(19) United States
(12) Patent Application Publication
(10) Pub. No.: US 2024/0353243 A1
(43) Pub. Date: Oct. 24, 2024

(54) UNIVERSAL INTERFACE

(71) Applicant: Georg Fischer Rohrleitungssysteme AG, Schaffhausen (CH)

(72) Inventors: Elmar HUFSCHMID, Albbruck (DE); Thomas HARTMANN, Ravensburg (DE); Calin CIOBANU, Brea, CA (US); Juergen STUMPP, Rafz (CH); Philipp KLEINBRUCKNER, Ramsen (CH)

(21) Appl. No.: 18/638,906

(22) Filed: Apr. 18, 2024

(30) Foreign Application Priority Data
Apr. 20, 2023 (EP) 23 168 841.7

(51) Int. Cl. G01D 11/28; G01D 11/24; G01D 21/02

(52) U.S. Cl. CPC G01D 11/28; G01D 11/24; G01D 21/02; G01D 2213/00

(57) ABSTRACT

A sensor arrangement for measuring properties of liquids and gases, including a probe, a probe holding element, the probe and the probe holding element configured to be connected to one another in a detachable manner, and a galvanically isolated interface that is formed by an inductive interface and/or a galvanically coupled interface, the galvanically isolated interface and/or the galvanically coupled interface being configured exclusively for energy transmission from the probe holding element to the probe. The sensor arrangement further includes at least one optical interface or at least one Bluetooth interface for bidirectional data transmission between the probe and the probe holding element.

### CROSS REFERENCE TO RELATED APPLICATIONS

This application claims benefit to European Patent Application No. EP 23 168 841.7, filed on Apr. 20, 2023, which is hereby incorporated by reference herein.

### FIELD

The invention relates to a sensor arrangement for measuring properties of liquids and gases.

### BACKGROUND

To analyse liquids and gases and their properties, sensors are often used in which a probe or a sensor is paired with a corresponding holding element in a detachable manner, which holding element is in turn securely connected via a cable to an evaluation unit. Different probes can be connected to the holding element, such as e.g. pH sensors, redox sensors, chlorine sensors, turbidity sensors, to mention only a few of the probes. In principle, all types of sensors that can be used for analysing liquids and gases can be connected to the holding element. Such sensors are to be cleaned, calibrated and adjusted frequently, which is why the two-part design is advantageous and the probe can easily be detached from the holding element. In addition, as was already mentioned previously, different probes can couple with the holding element as a result, which means that to analyse different properties of the liquid or gases, the same evaluation unit with securely connected holding element can be used and only the probe is to be exchanged.

EP 1 565 898 A1 discloses a modular evaluation unit in which a sensor module and an electronic module have an inductive interface that is used for energy and also data transmission, wherein the electronic module for energy supply is connected to the base transceiver station via a supply line and the data exchange takes place inductively.

DE 10 2019 118 712 discloses a sensor that is connected to a measurement system via a galvanically isolated connection. The data transmission between the sensor and the measurement system takes place via a first inductive interface and the energy transmission between measurement system and sensor takes place via a second inductive interface.

In the prior art presented above, the data and also the energy are transmitted via an inductive interface in each case. This has the disadvantage that the type of connecting point barely permits a tolerance, as only a slight enlargement of the distance between the two coils may disrupt the data transfer or substantially reduce the transmission rate.

### SUMMARY

In an embodiment, the present disclosure provides a sensor arrangement for measuring properties of liquids and gases, comprising a probe, a probe holding element, the probe and the probe holding element configured to be connected to one another in a detachable manner, and a galvanically isolated interface that is formed by an inductive interface and/or a galvanically coupled interface, the galvanically isolated interface and/or the galvanically coupled interface being configured exclusively for energy transmission from the probe holding element to the probe. The sensor arrangement further comprises at least one optical interface or at least one Bluetooth interface for bidirectional data transmission between the probe and the probe holding element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a sensor arrangement in which optical interfaces are arranged at an end;

FIG. 2 shows a schematic illustration of a sensor arrangement in which optical interfaces are arranged on parallel running surfaces of the sensor arrangement; and

FIG. 3 shows a schematic illustration of the placement of LEDs on a separate printed circuit board with optical waveguides.

### DETAILED DESCRIPTION

In an embodiment, the invention provides a sensor arrangement which enables secure and simple data transfer at a high transfer rate and can also be produced in a compact and inexpensive manner.

An embodiment of the invention provides a sensor arrangement that has at least one optical interface or at least one Bluetooth interface for bidirectional data transmission between probe and probe holding element.

The sensor arrangement according to an embodiment of the invention is used for the measurement of properties of liquids and gases. The sensor arrangement contains a probe that is designed as a sensor. Wherein all possible types of sensors that are suitable for analysing liquids and gases can be used. The sensor arrangement likewise contains a probe holding element that can be connected to the probe such that it can be detached again. The sensor arrangement according to an embodiment of the invention preferably has a galvanically isolated interface for energy transmission, which is formed by an inductive interface. Alternatively, the sensor arrangement according to an embodiment of the invention has a galvanically coupled interface for energy transmission, which is preferably formed by metallic contacting between the probe and the probe holding element. It has been shown as advantageous if, to that end, a metallically conductive metal sheet is arranged on the probe and on the probe holding element in each case, which metal sheets contact one another when the two components of the sensor arrangement are joined. This enables even higher energy transmission, e.g. for energy-intensive sensor elements. Of course, the galvanically coupled interface can also be designed differently, one galvanic element is preferably arranged on the probe to this end and one is arranged on the probe holding element and these can likewise be connected to one another such that they can be detached again if a galvanically coupled interface of this type is provided at the sensor arrangement according to an embodiment of the invention. In addition, it is also provided that the sensor arrangement has a galvanically isolated interface, by means of an inductive interface, and also a galvanically coupled interface, wherein both interfaces are in each case used exclusively for energy transmission, both if both are arranged on the sensor arrangement and if only one of the interfaces is arranged on the sensor arrangement according to an embodiment of the invention. The sensor arrangement according to an embodiment of the invention has at least one optical interface between the probe and the probe holding element for bidirectional data transmission or at least one Bluetooth interface between probe and the probe holding element for bidirectional data transmission. Of course, bidirectional data transmission is also understood to mean two unidirectional data transmissions. Wherein the Bluetooth interface on the probe and also on the probe holding element is suitable for data transfer with mobile communication terminals, such as mobile telephones, computers or tablets and also for communication with measurement terminals, control systems or calibration devices.

A preferred embodiment ensures that in each case one transmitter and one receiver of the optical interface are arranged on the probe and on the probe holding element, as a result of which the bidirectional data transmission is ensured. This means that one transmitter and one receiver are arranged both on the probe and on the probe holding element and the corresponding complementary elements are arranged opposite on the other component of the sensor arrangement.

An optical bidirectional data transmission additionally has the advantage that the quality of the data is examined. This means, if the received data do not correspond to the transmitted data or exceed a tolerance in the deviation of the signal quality, this is ascertained and a corresponding notification takes place, for example the probe must be cleaned or it is to be readjusted.

Of course, a data transmission by means of Hall, GM or MI sensors can also be provided.

It has been shown to be advantageous if the inductive interface is formed by printed circuit boards having conducting tracks. This enables a compact and exceptionally robust design of the sensor arrangement with high energy transmission.

It has been shown to be advantageous if the printed circuit boards that form the inductive interface are arranged parallel opposite one another.

It is advantageous if at least one printed circuit board of the inductive interface is arranged on the probe and at least one further printed circuit board of the inductive interface is arranged on the probe holding element.

It has been shown to be advantageous if in each case two printed circuit boards of the inductive interface are arranged on the probe and on the probe holding element, which enables a higher energy transmission. This results in two inductive interfaces being formed.

Preferably, the printed circuit boards of the inductive interface are arranged flat with respect to one another. It is advantageous if the printed circuit boards of the inductive interface run parallel to the longitudinal axis of the sensor arrangement.

It has been shown to be advantageous if the printed circuit boards of the inductive interface run parallel to the end face of the probe and the probe holding element.

Preferably, the transmitter of the optical interface is formed by an LED. This likewise enables a compact and energy-saving implementation of an optical interface.

It has been shown as advantageous if the probe and the probe holding element are of cylindrical design and can be plugged, twisted or screwed into one another.

Preferably, the optical interfaces are arranged at the end on the probe and on the probe holding element. This allows a compact design of the sensor arrangement.

In an advantageous embodiment, the optical interfaces are arranged on surfaces of the probe and of the probe holding element, which run parallel to the longitudinal axis and to one another. This means that the transmitters and receivers of the optical interface are aligned at right angles to the longitudinal axis.

It is advantageous if, when using a Bluetooth interface, the Bluetooth interface is arranged in place of the arrangement of the optical interface.

In a preferred embodiment, the transmitters and receivers of the optical interface are arranged in an axially opposite manner. As a result, the distance between transmitters and receivers can be set optimally and delivers high data transmission and a good quality of the data.

It has also been shown to be advantageous if the optical interfaces are arranged at the end on the probe and on the probe holding element and the transmitters and receivers are placed on a separate printed circuit board which is aligned parallel to the longitudinal axis.

Preferably, the transmitter and receiver of the optical interfaces are arranged on a different printed circuit board from the inductive interface.

That is to say that it is advantageous if the transmitter and receiver of the probe and the sensor and receiver of the probe holding element are in each case arranged on a different printed circuit board from the conducting tracks of the inductive interface in the probe and in the probe holding element.

It is advantageous if the sensor arrangement according to an embodiment of the invention has optical waveguides to better carry the optical signal. This allows a more flexible arrangement of the transmitter and receiver of the optical interface. Thus, for example, the signal of the transmitter of an LED can be transmitted by means of optical waveguides.

All configuration options can be freely combined with one another.

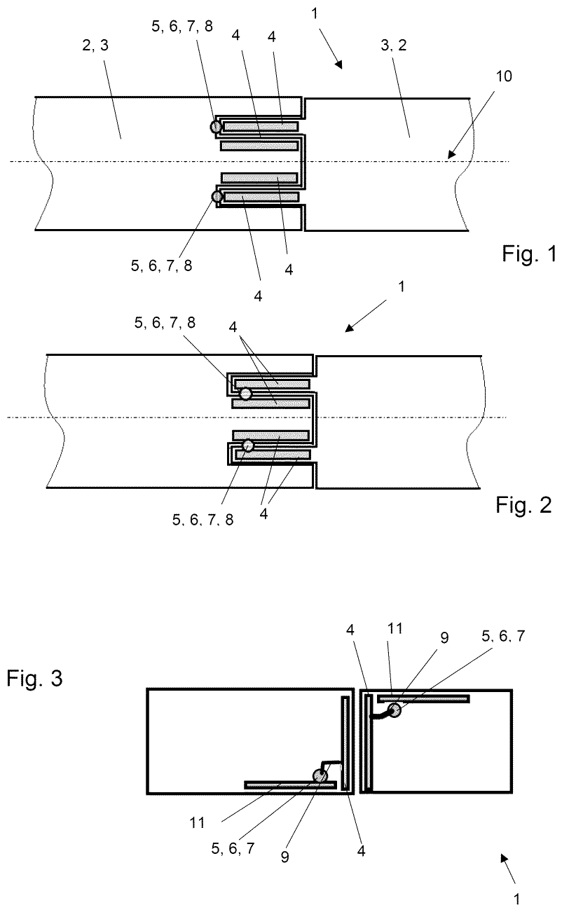

The drawing illustrated in FIG. 1 shows a schematic illustration of a sensor arrangement 1 having a probe 2 and probe holding element 3; it is of no significance which end of the two parts is designed with grooves or tongues, which is why both ends have both reference signs in each case. The embodiments illustrated in FIGS. 1 and 2 show ends of the probe 2 and the probe holding element 3, which have a tongue and groove joint and interlock. The sensor arrangement 1 has inductive interfaces 4 which are formed by conducting tracks on printed circuit boards 4. The embodiments depicted in FIGS. 1 and 2 have two galvanically isolated interfaces 4 which run parallel to the longitudinal axis 10. The interfaces 4 are formed by printed circuit boards 4 running parallel to one another and to the longitudinal axis 10, which have conducting tracks for exclusive inductive energy transmission. In FIGS. 1 and 2, two pairs of such printed circuit boards 4 are illustrated in each case; of course a single pair can also form the inductive interface or yet further printed circuit boards can be used for the inductive interface. In the schematic illustration in FIG. 1, the optical interfaces 5 are arranged at the end and the orientation thereof is parallel to the longitudinal axis, which is used for the data transmission. In order to ensure the bidirectional data transmission, two optical interfaces 5 are to be provided. Alternatively, the optical interfaces 5 can, as illustrated in FIG. 2, also be arranged on surfaces on the probe 2 and on the probe holding element 3, which run parallel to the longitudinal axis 10. In FIG. 2, the optical interface 5 is aligned at right angles to the longitudinal axis. Alternatively, a Bluetooth interface 8 can also be used in place of the optical interface 5.

FIG. 3 shows a schematic illustration of a sensor arrangement 1 according to an embodiment of the invention, in which an optical waveguide 9 is used for transmitting the optical signal of the optical interface 5. In the illustration depicted, the signal of the transmitter 6 is projected in such a manner by means of optical waveguides 9 that the receiver 7 can readily capture the signal. In addition, in the embodiment illustrated in FIG. 3, the printed circuit boards 4 of the inductive interface run parallel to the end faces of the probe 2 and the probe holding element 3. The transmitter of the optical interface 5, preferably an LED, is coupled with an optical waveguide 9. It has been shown to be advantageous if the transmitter and the receiver 7 are arranged on a different printed circuit board 4 from the conducting tracks of the inductive interface 4. It has been shown to be advantageous if the printed circuit board 11 of the transmitter 6 and receiver 7 are at a 90° angle to the printed circuit board of the inductive interface 4. Wherein the arrangement of the printed circuit boards 4, 11 in FIG. 3 is only exemplary and other arrangements are provided, in which the transmitters and receivers are on a separate printed circuit board or not on the same printed circuit board as the conducting tracks of the inductive interface. In FIGS. 1 to 3, no galvanically coupled interface is depicted, but it is self-evident that this is formed by conventional metallic elements, at least one of which is arranged on the probe 2 and at least one of which is arranged on the probe holding element 3 in each case.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Sensor arrangement
2 Probe
3 Probe holding element
4 Inductive interface/printed circuit boards
5 Optical interface
6 Transmitter optical interface
7 Receiver optical interface
8 Bluetooth
9 Optical waveguide
10 Sensor arrangement longitudinal axis
11 Printed circuit board

1. A sensor arrangement for measuring properties of liquids and gases, comprising:
a probe;
a probe holding element, the probe and the probe holding element configured to be connected to one another in a detachable manner;
a galvanically isolated interface that is formed by an inductive interface and/or a galvanically coupled interface, the galvanically isolated interface and/or the galvanically coupled interface being configured exclusively for energy transmission from the probe holding element to the probe; and
at least one optical interface or at least one Bluetooth interface for bidirectional data transmission between the probe and the probe holding element.

2. The sensor arrangement according to claim 1, wherein in each case one transmitter and one receiver of the optical interface is arranged on the probe and the probe holding element.

3. The sensor arrangement according to claim 1, wherein the inductive interface is formed by printed circuit boards having conducting tracks.

4. The sensor arrangement according to claim 3, wherein the printed circuit boards of the inductive interface are arranged parallel to and opposite one another.

5. The sensor arrangement according to claim 1, wherein the printed circuit boards of the inductive interface are in each case arranged parallel to an end face of the probe and the probe holding element.

6. The sensor arrangement according to claim 2, wherein the transmitter and receiver of the optical interfaces are arranged on a different printed circuit board from the inductive interface.

7. The sensor arrangement according to claim 2, wherein the transmitter of the optical interface is formed by an LED.

8. The sensor arrangement according to claim 1, wherein the probe and the probe holding element are cylindrical and are configured to be plugged, twisted or screwed into one another.

9. The sensor arrangement according to claim 1, wherein the optical interfaces are arranged at an end on the probe and on the probe holding element.

10. The sensor arrangement according to claim 2, wherein the transmitters and receivers of the optical interface are aligned parallel to a longitudinal axis.

11. The sensor arrangement according to claim 2, wherein the transmitters and receivers of the optical interface are aligned at right angles to a longitudinal axis.

12. The sensor arrangement according to claim 1, further comprising optical waveguides configured to better capture or more easily position the optical signal.
